(19) United States
(12) Patent Application Publication
(10) Pub. No.: US 2004/0114869 A1
(43) Pub. Date: Jun. 17, 2004

(54) Mode converter including tapered waveguide for optically coupling photonic devices

(76) Inventors: Eugene E. Fike, Amesbury, MA (US); John Fijol, Shrewsbury, MA (US); Philip B. Keating, Salem, MA (US); Donald I. Gilbody JR., Waltham, MA (US); John J. LeBlanc, North Andover, MA (US); Stuart A. Jacobson, Lexington, MA (US); Michael B. Frish, Andover, MA (US); Carl C. Bozler, Waltham, MA (US); Craig L. Keast, Groton, MA (US); Michael Fritze, Acton, MA (US); Jeffery M. Knecht, Brookline, NH (US)

Correspondence Address: TESTA, HURWITZ & THIBEAULT, LLP, HIGH STREET TOWER, 125 HIGH STREET, BOSTON, MA, 02110, US

(21) Appl. No.: 10/666,914

(22) Filed: Sep. 19, 2003

Related U.S. Application Data
(63) Continuation-in-part of application No. 10/099,482, filed on Mar. 15, 2002.
(60) Provisional application No. 60/298,753, filed on Jun. 15, 2001.
(60) Provisional application No. 60/351,690, filed on Jan. 25, 2002.
(60) Provisional application No. 60/412,250, filed on Sep. 20, 2002.

(51) Int. Cl. G02B 6/26

(52) U.S. Cl. 385/43; 385/28

(57) ABSTRACT

A mode converter including a silicon waveguide core deposited over a first silicon dioxide cladding layer. The silicon waveguide core is formed such that a first end of the silicon waveguide core has a larger cross-sectional area than a second end of the silicon waveguide core. The silicon waveguide core may include a vertical taper and/or a lateral taper.

### CROSS-REFERENCE TO RELATED APPLICATIONS

This application is a continuation-in-part of U.S. nonprovisional patent application Ser. No. 10/099,482 filed Mar. 15, 2002, which claims the benefits of and priority to U.S. provisional patent application serial No. 60/298,753 filed Jun. 15, 2001, and U.S. provisional patent application serial No. 60/351,690 filed Jan. 25, 2002, all of which are herein incorporated by reference in their entireties. This application also claims the benefits of and priority to U.S. provisional patent application Serial No. 60/412,250 filed Sep. 20, 2002, the disclosure of which is herein incorporated by reference in its entirety.

### FIELD OF THE INVENTION

This invention relates generally to systems and methods for coupling photonic devices, and more particularly to mode converters having vertical and/or lateral tapers.

### BACKGROUND OF THE CONVENTION

As a result of the numerous applications for optoelectronic technologies in telecommunications and data communications, many advances are being made in the development of components such as laser sources, optical amplifiers, attenuators, switches, and multiplexers/demultiplexers (MUX/DEMUX). The use of planar technologies has been adopted in the development of many of these devices utilizing the fabrication models developed in the microelectronics industry to take advantage of the extensive existing manufacturing infrastructure. Ubiquitous in the fabrication of planar optical components are optical waveguides, which are used to confine and direct optical radiation, analogous to electrons traveling through metal interconnects in integrated circuits.

Semiconductor lasers typically have waveguide cavities with cross sections that are much smaller than silica waveguides, on the order of 1-2 μm, resulting in a mode field that does not efficiently couple to a single mode fiber (SMF). The smaller waveguide cross sections result from the need to maintain single mode behavior in the waveguide, despite an index contrast between the core and cladding layers which is much higher than those for silica waveguides. The large mode mismatch between an SMF and semiconductor laser leads to a large coupling loss, as high as −8.5 dB, when an SMF is directly butt coupled to a laser. To reduce the optical loss, complex packaging solutions have been developed utilizing ball lenses, micro lenses, or lensed fiber mounted in expensive hermetic packages. As an alternate approach, work has been presented utilizing adiabatic waveguide tapers, which are monolithically fabricated on the laser substrate, to allow the output mode field of the laser to expand and match the mode field of an optical fiber. The use of mode conversion between the laser and fiber reduces the coupling loss as low as 1 dB, but at the expense of additional processing difficulty and added cost.

In addition to semiconductor lasers, planar optical circuits based on high index contrast waveguides are being developed. The desire to migrate to high index contrast devices is driven by several factors, one of which is the ability to integrate active components comprised of III-V semiconductor waveguide devices. Another motivation is the high optical confinement of high index contrast waveguides, which allows for tighter bend radii and reduced die size. However, in all cases, a difficulty in fabricating mode converters arises from either the need to form structures with a vertical relief or else from utilizing designs that incorporate overlapped laterally tapered waveguides. The vertical relief is a deviation from the planar processing common to integrated circuit manufacturing, upon which the planar optical waveguide fabrication processes are based. Therefore, attempts to develop integrated adiabatic tapers typically require complex or novel processing, which increases cost and decreased device yield.

### SUMMARY OF THE INVENTION

The invention, in one embodiment addresses the deficiencies of the prior art by providing optical mode converters capable of low loss optical coupling of optical fibers to high index contrast waveguide devices and arrays. The mode converters include adiabatic waveguide tapers fabricated from silicon-on-insulator (SOI) wafers, utilizing the silicon device layer as a waveguide core and the buried oxide layer as the underlying clad. The input and output ends of the tapers may be polished facets. The mode shape at the input typically matches that of a single mode fiber, while the output ends can be sized to match various waveguide device mode shapes. Semiconductor planar processing techniques are employed to form the tapers upon commercial SOI wafers. An additional oxide layer may be deposited upon the tapers to provide a symmetric clad around the silicon. The input and output facets are then lapped and polished, using a precision end point process, after which an anti-reflective (AR) coating may be applied. The resulting mode converter structure has a high index contrast providing high optical confinement and can be designed with a high mode field reduction that matches well with other high index contrast waveguides.

In one aspect, the invention provides a mode converter including a silicon waveguide core deposited over a first silicon dioxide cladding layer. The silicon waveguide core is polished such that a first end of the silicon waveguide core has a larger cross-sectional area than a second end of the silicon waveguide core. In one embodiment, the silicon waveguide core includes a vertical taper. The silicon waveguide core may include a lateral taper as well. In one embodiment, the silicon waveguide core has an angled top surface and a flat bottom surface. In various embodiments, the slope of the vertical taper matches the slope of the lateral taper.

In some embodiments of the mode converter, a second silicon dioxide cladding layer is deposited over the silicon waveguide core to provide a symmetric clad. In various embodiments, the first silicon dioxide cladding layer and the silicon waveguide core are formed over a silicon substrate. In one embodiment, the second end of the silicon waveguide core has at least one dimension of about 1 μm.

In another aspect, the invention provides a method of forming a mode converter. The method includes depositing a silicon waveguide core over a first silicon dioxide cladding layer and polishing the silicon waveguide core such that a first end of the silicon waveguide core has a larger cross-sectional area than a second end of the silicon waveguide core. In one embodiment, the polishing step includes vertically tapering the silicon waveguide core. In one embodiment, the method includes tapering the silicon waveguide core laterally using a lithographic mask and etch process. In some embodiments, the method includes mode matching the first end to a single mode fiber. In various embodiments, the method includes mode matching the second end to one of a group consisting of a waveguide device and a semiconductor laser.

In yet another aspect, the invention provides a mode converter including a silicon waveguide core deposited over a first silicon dioxide cladding layer. The silicon waveguide core is tapered using a gray-scale lithographic mask and etch process such that a first end of the silicon waveguide core has a larger cross-sectional area than a second end of the silicon waveguide core. In one embodiment, the second end of the silicon waveguide core has at least one dimension of about 0.25 μm.

In still another aspect, the invention provides a method of forming a mode converter. The method includes depositing a silicon waveguide core over a first silicon dioxide cladding layer and using a gray-scale lithographic mask and etch process on the silicon waveguide core such that a first end of the silicon waveguide core has a larger cross-sectional area than a second end of the silicon waveguide core.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention.

FIG. 1A is a diagram that shows an illustrative embodiment of an optical fiber coupling device according to principles of the invention;

FIG. 1B is a diagram that shows a section through another illustrative embodiment of an optical fiber coupling device according to principles of the invention;

FIGS. 2A, 2B and 2C are diagrams that present the results of a calculation of optical power propagation through an illustrative optical fiber coupling device, in which optical power is input from the bottom in the illustrated structure;

FIGS. 3A, 3B and 3C show an exemplary gray scale mask utilized in a process for fabricating a device for coupling an optical fiber to a SOI waveguide, according to principles of the invention;

FIG. 4 shows an illustrative embodiment of a mode converter having a tapered waveguide formed on a SOI wafer according to the invention;

FIG. 5 shows the output of a tapered mode converter coupled to a single mode fiber according to the invention;

FIG. 6 depicts an optical waveguide device coupled to a pair of tapered mode converters according to the invention;

FIG. 7A is a diagram that shows a top view of a first illustrative embodiment of an optical component that provides a fiber to SOI transition, according to principles of the invention;

FIG. 7B is a diagram that shows a section through the thickness of the optical component shown in FIG. 7A, according to principles of the invention;

FIG. 8A is a diagram that shows a top view of a second illustrative embodiment of an optical component that provides a fiber to SOI transition, according to principles of the invention;

FIG. 8B is a diagram that shows a section through the thickness of the optical component shown in FIG. 8A, according to principles of the invention;

FIGS. 9A and 9B are diagrams that show cross-sections of examples of illustrative transition structures used to minimize reflection of the light from the refraction interface between the waveguide and the optical fiber, according to principles of the invention;

FIGS. 9C, 9D and 9E are diagrams that show an illustrative example of the fabrication process used to manufacture a transition structure such as that shown in FIG. 9B, according to principles of the invention;

FIGS. 10A and 10B are diagrams that show a third illustrative embodiment comprising a diffraction grating, in top view and in cross-section, respectively, according to principles of the invention;

FIGS. 11A and 11B are diagrams that show a fourth illustrative embodiment comprising an etalon, in top view and in cross-section, respectively, according to principles of the invention;

FIGS. 12A and 12B are diagrams that show an illustrative embodiment of a micro electro-mechanical optical switch, in top view and in cross-section, respectively, according to principles of the invention;

FIG. 13 depicts a tapered waveguide coupled to a SMF and a diode laser, according to the invention;

FIG. 14 is a diagram that shows three illustrative taper designs for optical couplers of the invention; and

FIG. 15 is a schematic diagram of an illustrative application using the optical coupler of the invention.

### DETAILED DESCRIPTION OF THE INVENTION

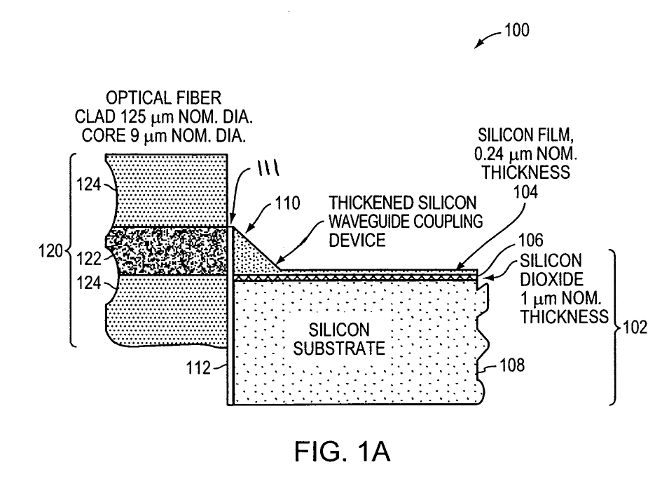

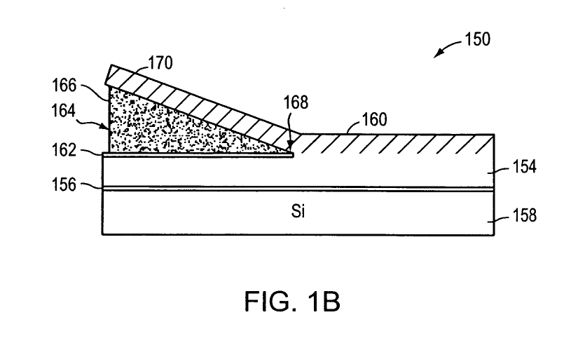

FIG. 1A is a diagram 100 that illustrates an exemplary embodiment of the coupling device fabricated on a silicon-based wafer 102. A SOI wafer 102 is one that has been fabricated with a thin (approximately 250 nm, or 0.25 μm) layer of high-refractive index single crystal silicon (Si) 104 overlaying a layer of relatively-low refractive index silicon dioxide (SiO₂) 106, which in turn has been grown or deposited on a silicon single crystal wafer substrate 108. In electronic applications, the oxide layer serves as an electrical insulator, hence the term silicon-on-insulator. In this application, the terms coupling device, mode converter, and tapered waveguide are, in many cases, used interchangeably.

Fabrication of SOI wafers is a highly developed commercial process wherein the silicon-on-insulator film can be made uniform in thickness to within 40 Å and the insulating layer can be made arbitrarily thick. When used as an optical waveguide, the thin Si layer 104 serves as the core guiding layer. Its uniformity enables optical propagation with losses of less than 0.1 db/cm. By using advanced lithography, patterns having dimensions as small as 0.2 μm are created in the silicon layer, and equally small optical structures may be fabricated simply by etching into and through the silicon. In some circumstances another layer of SiO₂ (not shown) may be deposited or formed upon the silicon guiding layer 104. If the structure includes a top layer of SiO₂, the structure has a total of four layers.

Referring still to FIG. 1A, according to principles of the invention, the end of the waveguide 110 where light enters or exits the silicon layer 104 is thickened. Thickening may be accomplished, for example, by depositing, growing, or attaching additional silicon upon the silicon layer 104. The thickened region may include thin barrier layers (not shown) of oxide or other materials that are essentially transparent to transmitted light, but are included to simplify fabrication and shaping processes. In the embodiment shown in FIG. 1A, the thickened silicon section 110 is depicted as having a planar facet at one end 111. In other embodiments, the end 111 of the thickened segment may be shaped, for example with curved surfaces in place of the planar facets, or coated, for example with anti-reflective materials, to optimize power transfer to or from optical fibers. The end 111 of the thickened section can be an input or an output. Optionally, the end 111 of the thickened silicon waveguide 110 can include one or more layers of anti-reflection coating material 112 to optimize power transfer to or from other components. In FIG. 1A, an optical fiber 120, having a core 122 and having an annular cladding material 124 outside the core 122, is shown as a component from which power is transferred.

The height of the thickened silicon section 110 varies from that of the silicon guiding layer 104, nominally 0.25 μm, to a dimension slightly larger than that of the optical fiber core 122 to which the waveguide couples optically, nominally 10 μm, providing a mode field dimension change on the order of 40:1. Mode field dimension changes on the order of 50:1 are also achievable. In one embodiment the thickened silicon 110 is in the shape of a taper where the rate of change of waveguide height along its length is optimized to minimize loss of optical power by mode conversion and radiation. The width of the waveguide taper may also be controlled to optimize transmitted power.

FIG. 1B is a diagram 150 that shows a section through another illustrative embodiment of an optical coupler comprising a taper fabricated on a semiconductor substrate, such as a silicon substrate 158. The substrate 158 is preferably single crystalline material having a selected crystallographic orientation, with a selected crystallographic direction oriented at a desired angle to a surface normal of the substrate 158. A layer 156 of material is disposed adjacent the substrate 158. The layer 156 comprises a material having a refractive index less than a semiconductor that is used as an optical waveguide 154 that is disposed adjacent the layer 156. A second layer 160 of material having a refractive index lower than the material of the optical waveguide 154 is disposed adjacent the optical waveguide 154.

In a preferred embodiment, the substrate 158 is silicon, the layer 156 is silicon dioxide, the semiconductor optical waveguide 154 is silicon, and the second layer 160 is silicon dioxide. In some embodiments, the thickness of one or both of layers 156 and 160 is at least 500 nm. In other embodiments, the substrate 158 is another elemental semiconductor, a semiconductor such as silicon-germanium alloy, a compound semiconductor such as InP or GaAs or a ternary or higher order alloy of such compound semiconductors. In some embodiments, the optical waveguide 154 is another elemental semiconductor, a semiconductor such as silicon-germanium alloy, a compound semiconductor such as InP or GaAs or a ternary or higher order alloy of such compound semiconductors.

In some embodiments, the layer 156 and the layer 160 comprise a selected one of silicon dioxide, silicon nitride, non-stoichiometric silicon nitride, silicon oxynitride, sapphire, and air. The layer 156 and the layer 160 can comprise the same material or the layer 156 can comprise different material than the layer 160. Additional layers, not shown in FIG. 1B because they lie outside the plane of the section shown, of material having an optical index less than that of the semiconductor are present to completely surround the layer of semiconductor material 154. The layers 156 and 160, along with the additional layers not shown, provide a structure that causes light that propagates within the semiconductor layer 154 to be confined within the semiconductor layer 154.

The optical coupler comprises a semiconductor structure 164 communicating light between a first cross-sectional area at a first end 166 thereof and a second cross-sectional area at a second end 168 thereof. The semiconductor structure 164 is preferably made from silicon, but can be made from other semiconductor materials, such as those enumerated above. The light has a propagation direction in the semiconductor structure 164. The semiconductor structure 164 has a cross-section defined upon a plane substantially perpendicular to the propagation direction of the light. In one embodiment, in which the semiconductor structure 164 comprises silicon, the cross section has a cross-sectional dimension accurate to within a ±50 nm tolerance of a desired value. It has been found that maintaining the silicon structure within such tolerance improves the parameters of performance and/or characteristics of the optical coupler, as will be described in greater detail below. A layer 170 of material having an optical index less than that of the semiconductor structure 164 is disposed adjacent the semiconductor structure 164, so as to confine light within the semiconductor structure 164.

In some embodiments, the semiconductor structure 164 has a tapered shape that is defined by a change of a dimension of one cross-section compared to the corresponding dimension of a second cross-section. In a preferred embodiment, the change of a dimension is less than two percent of the distance between adjacent cross-sections, the distance being measured along the propagation direction of light within the semiconductor structure 164. As shown in FIG. 1B, in some embodiments, a layer 162 of material is provided between layer 154 and structure 164, the layer 162 being sufficiently thin so as to be substantially transparent or optically innocuous with regard to the light that propagates through structure 164 and travels within layer 154. The layer 162 comprises material that is resistant to chemicals that etch the material from which semiconductor structure 164 is made. In a preferred embodiment, the semiconductor structure 164 is silicon, and the layers 162 and 170 are silicon dioxide. The layer 162 is an etch stop layer having a thickness sufficient to avoid pinholes or other defects that would permit etching of an underlying layer. The minimum thickness required for etch stop layer 162 to be effective will in general depend on the method by which layer 162 is created. Other attributes of the semiconductor structure 164 will be described in greater detail below.

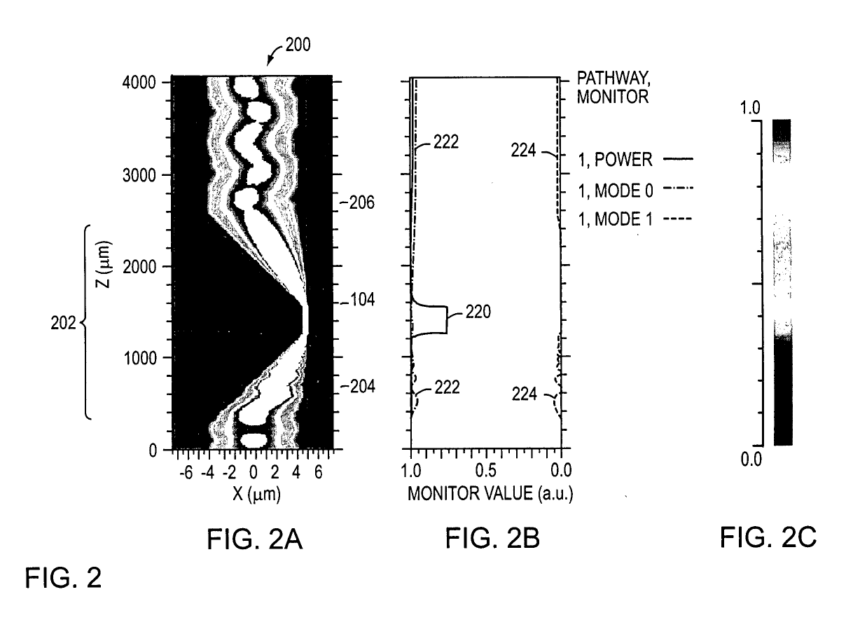

FIG. 2A is a diagram 200 that illustrates a calculation of the optical power propagating through a composite two-dimensional waveguide structure 202 featuring a tapered input section 204 and a tapered output section 206. The refractive indices of the materials comprising this structure are selected to simulate Si as the core material, with oxide as the clad material on both sides of the Si. The tapered input section 204 (corresponding to the thickened silicon waveguide 110 of FIG. 1A) receives light from a computed mode field similar to that created by a conventional optical fiber 120. The light propagates through the tapered input section 204 into a thin Si layer 104 capable of supporting only a single mode. The light transits the thin Si section 104 and exits through the output section 206. In FIG. 2A, the optical power distribution within the composite waveguide is illustrated by color coding. FIG. 2C shows the color code in units of relative power.

In FIG. 2B, line 220 shows the power contained in the Si core 104 of the waveguide at each position (denoted by the dimension Z in units of μm) along its length, but integrated in the x-direction across the width. Also shown in FIG. 2B is the power in each of the first two propagation modes. Mode 0 is illustrated by line 222, and mode 1 by line 224. These curves show that approximately 97% of the power entering the waveguide also exits the waveguide. In the thin single-mode region, only about 70% of the power (see line 220) is contained within the Si core 104, and the remaining power is guided evanescently within the oxide clad material. In the tapered input region 204, some transfer of power back and forth between Mode 0 and Mode 1 occurs, but more than 98% of the output power remains in Mode 0 (see line 222) as is desired for efficient coupling to an output optical fiber.

Apparatus built according to principles of the invention differ from conventional adiabatic tapers and from prism couplers in that the thickened silicon section 110 is directly attached to the waveguide 104, is formed substantially of the same material as the guiding layer, and provides for a continuous change in height in the direction of light propagation. Those skilled in the art of optical waveguide design and fabrication have in the past generally precluded consideration of these so-called vertical tapers. Procedures for fabricating vertical tapers upon silicon or other substrates of semiconductor materials by conventional deposition, lithographic, and etching processes were considered to be impractical for reliable fabrication in high-volumes. Processes for accomplishing the waveguide thickening are therefore a novel feature of the invention.

Vertically tapered waveguides are formed by a modification of standard semiconductor fabrication techniques. The general steps of standard semiconductor processing techniques, as is known in the art, include depositing a uniform layer of a photoresist material on a silicon wafer, then irradiating the photoresist with a pattern of light, and subsequently developing the photoresist by a chemical process that removes either the irradiated or the non-irradiated photoresist to expose bare silicon in the desired pattern. Thereafter, the exposed silicon is removed to a predetermined depth by an etching process. In a later step, the remaining photoresist is removed with yet another process. During the etching of the silicon, some of the remaining photoresist is also etched. Typically, the thickness of the photoresist is chosen to preclude etching of silicon in areas beneath photoresist that is not removed when developed.

In conventional photolithography, the light utilized in the patterning step is created in a photolithography tool. The illumination pattern is created by a mask placed in the path between the photolithography light source and the silicon wafer. In the standard optical lithography process, the mask is a glass plate with patterned areas blocked by an opaque material such as chrome. The transparent, or unblocked, areas transmit light to the silicon, while the blocked areas prevent light transmission. During the duration of the exposure in the standard optical lithography process, light projected through the mask onto the photoresist is either substantially “on” in unblocked areas or substantially “off” in blocked areas. The subsequent photoresist developing process ideally either fully removes the photoresist or removes substantially none at all. Thus, conventional lithography can be thought of as a “binary” process requiring the use of a high contrast resist for optimum performance. The subsequent silicon etch step removes exposed silicon at a first rate, generally fixed or substantially constant in time, and described in terms of depth of etch per unit of time, while removing remaining photoresist at a different, usually much slower, rate. The ratio of the two rates is called the etch ratio.

In contrast to the conventional photolithographic method, the gray-scale technique utilizes a mask that is designed to project onto the photoresist a photolithography light beam of variable intensity as a function of position. This is achieved by pixelation of the desired pattern with a pitch chosen such that the pixel structure is not resolved by the lithography projection system. Thus the image is a simple two-dimensional intensity pattern containing only zeroth order diffraction components. Furthermore, the resist is designed so that its depth of removal during the developing step is dependent upon the exposure it receives.

Typically, a low contrast resist provides optimum performance, in contradistinction to the high contrast resist used in conventional photolithography. As a result, when the photoresist irradiated through the gray-scale mask is developed, the resulting photoresist pattern is in general not either substantially “on” or substantially “off.” Instead, the photoresist is patterned so that the thickness at each point is determined by the local exposure, resulting in a photoresist layer having varying thickness determined at least in part by the intensity of illumination that reached the photoresist at specific locations. Thus, gray scale lithography can be thought of as an “analog” process, rather than as a “binary” process, in that it provides a range of photoresist thickness, rather than merely the presence or absence of photoresist at some location.

When the photoresist layer is subjected to the subsequent silicon etch step, the photoresist is etched as well, although at a different rate. The thinner regions of photoresist are fully removed in a shorter time interval that the thicker regions of photoresist. Underlying silicon is exposed at an earlier time than the silicon under thicker regions of photoresist. The depth to which the underlying silicon is etched is therefore determined by the thickness of the photoresist after being developed, the etch ratio, and the etch time. The result is that the depth of the silicon etch can be made to vary across the silicon surface in a predetermined fashion. In this way, three dimensional relief patterns can be transferred from the resist to the underlying silicon layer.

The following steps are utilized in conjunction with the gray-scale mask technique to create on SOI wafers arrays of waveguides having vertical taper input and output structures according to the principles of the invention. The steps need not be done in the order they are listed, and not every step must be performed to form a SOI wafer with a vertical taper.

1. A SOI wafer is selected. In some embodiments, this wafer can have been previously processed to include etched structures as well as deposited films to create, for example, the thin waveguides that transmit light to and from the vertical tapers.

2. A thin layer of oxide is deposited on the silicon.

3. The wafer is coated with photoresist, patterned with openings in the regions desired for the vertical tapers, and developed in the conventional manner.

4. The portions of thin oxide layer exposed by the openings in the photoresist mask are removed by etching, thereby exposing the thin silicon layer below the openings.

5. The remaining photoresist is stripped away.

6. A combination of selective and non-selective epitaxial silicon is grown on top of the wafer, providing high quality epitaxial silicon in the regions of the exposed silicon, and poly-silicon growth in regions far from the exposed silicon. This epitaxial layer is grown to the desired maximum height of the vertical taper, which is nominally 11 μm in some embodiments.

7. Optionally, depending on the flatness of the epitaxial layer, polishing of the top of the layer can be performed.

8. Photoresist is spun on top of the epitaxial silicon and patterned by irradiation through the gray scale mask.

9. The photoresist is developed and the wafer is subjected to a silicon etch, transferring the gray scale pattern into the epitaxial silicon as described above. The thin oxide layer on top of the thin silicon in areas not subjected to the removal step 4 above serves as an etch stop preventing removal of silicon below it.

10. Optionally, a smoothing process (such as thermal oxidation followed by a strip) can be performed on the vertical taper structure.

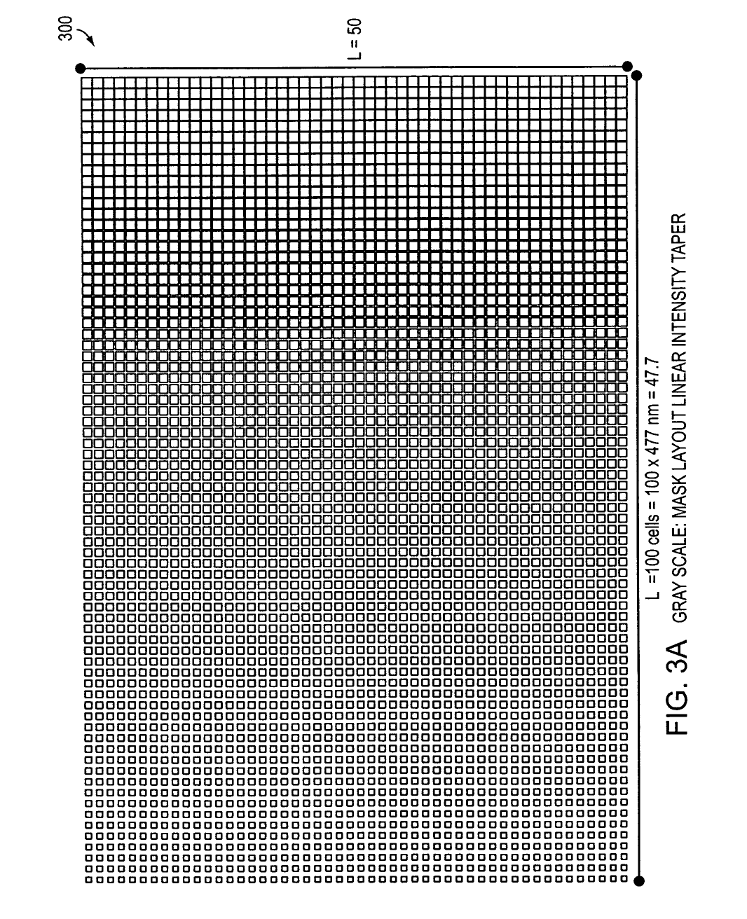

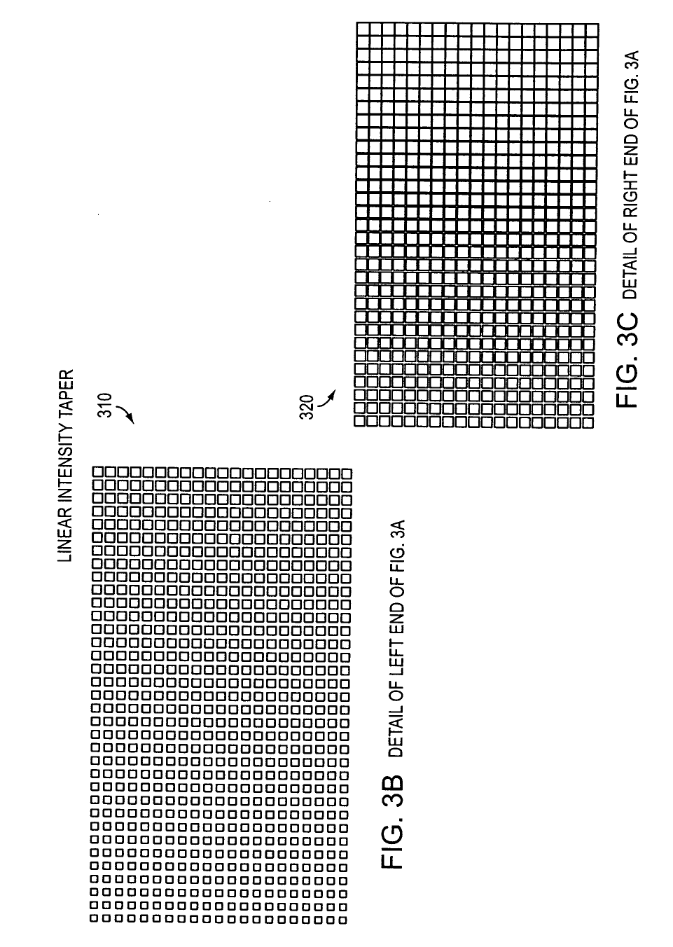

FIGS. 3A, 3B and 3C are drawings of an exemplary gray scale lithography mask utilized for fabrication of the vertical taper structure. FIG. 3A shows the entire mask, 300, design to provide a linear change in open area, and thus exposure, from left to right. There is no variation from top to bottom. FIG. 3B shows a detailed view of a section of the left side, 310, of the mask while FIG. 3C shows a detailed view of the right side, 320.

Tapered waveguides may be formed by first laterally tapering the waveguide using a conventional mask and etch process, and then polishing the waveguide to form a vertical taper. The mode converters include adiabatic waveguide tapers fabricated from SOI wafers, utilizing the silicon device layer as a waveguide core and the buried oxide as the underlying clad. The mode shape at the input typically matches that of a single mode fiber, while the output ends can be sized to match various waveguide device mode shapes, typically ranging from about 1 μm to about 5 μm. Semiconductor planar processing techniques are employed to form the tapers upon commercial SOI wafers. An additional oxide layer may be deposited upon the tapers to provide a symmetric clad around the silicon. Once fabricated, the wafers are diced into chips containing rows of tapers. The input and output facets are then lapped and polished, using a precision end point process, after which an AR coating may be applied. The chips are aligned and bonded to either single fibers or V-groove fiber arrays, creating the final pigtailed mode converter device. The insertion loss for completed mode converters ranges from about 0.5 dB to about 1 dB depending upon output facet size and asymmetry.

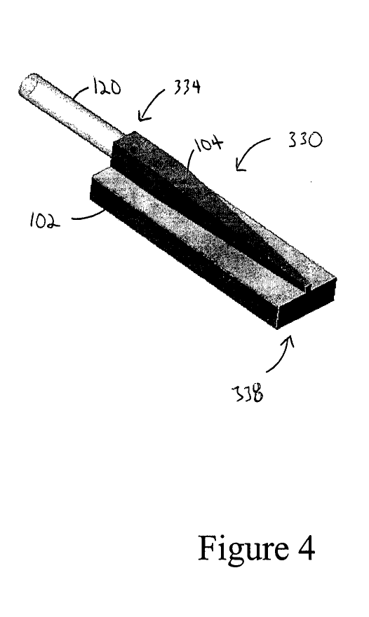

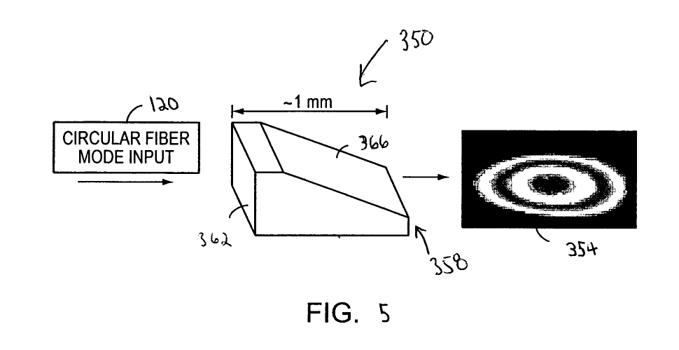

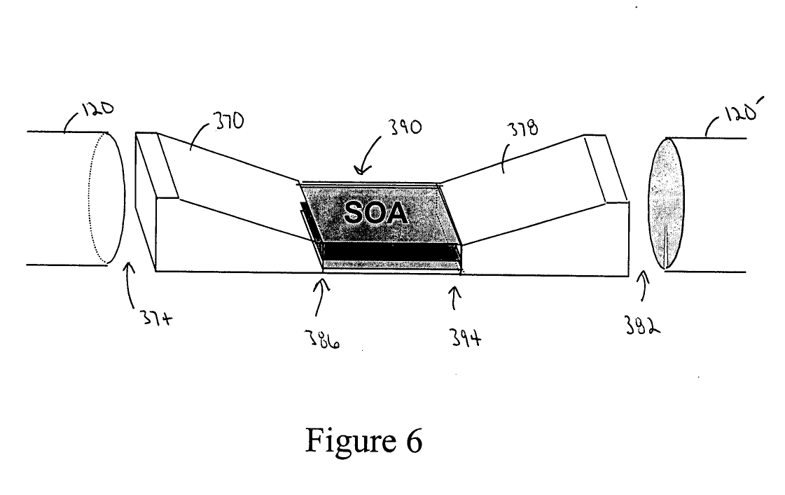

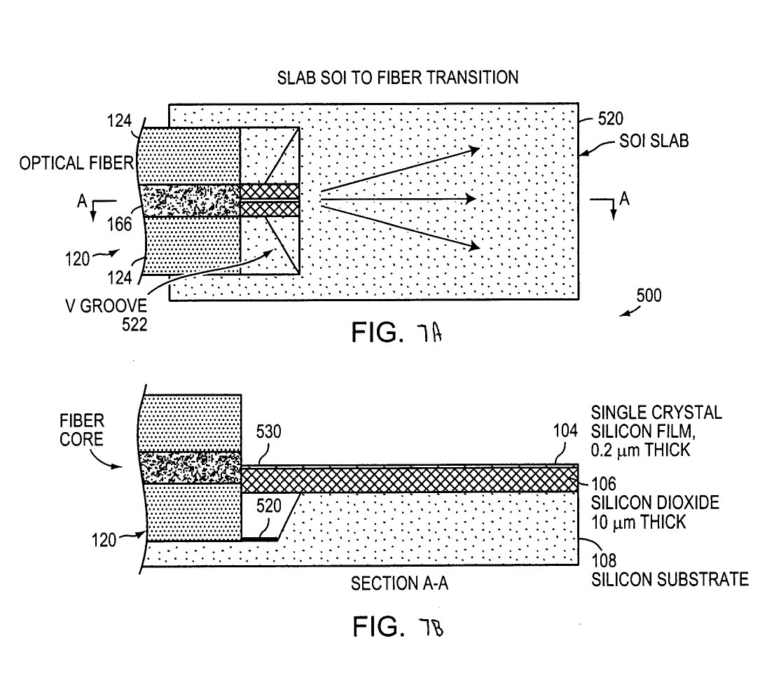

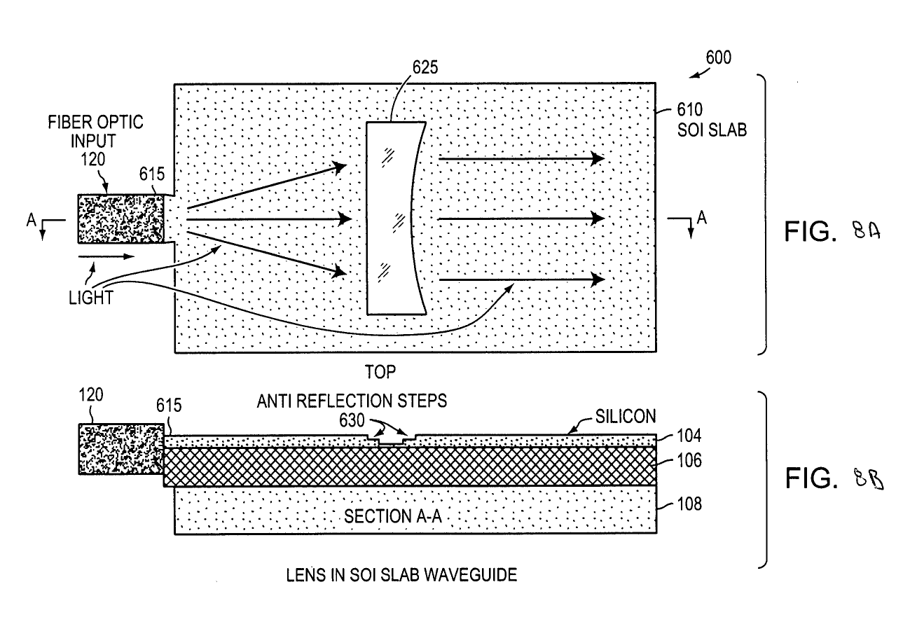

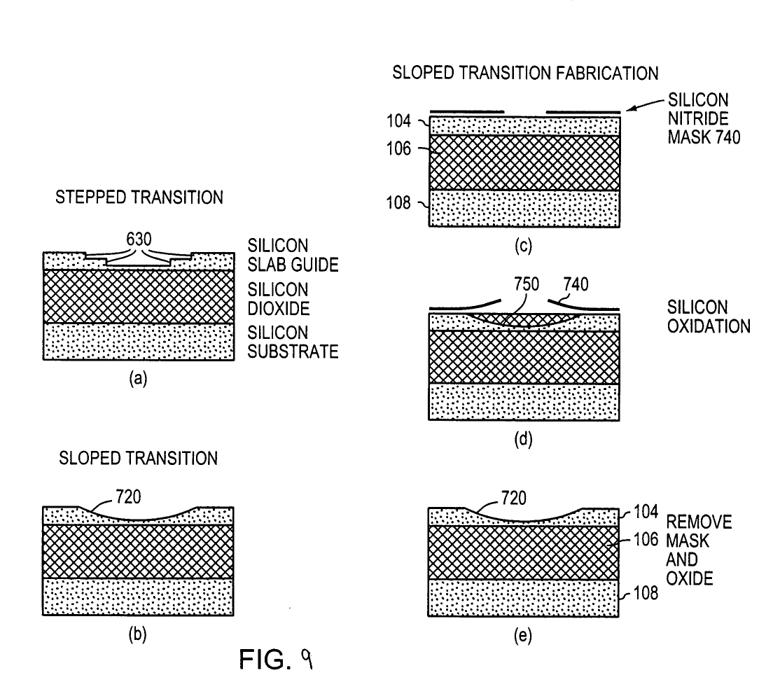

FIG. 4 shows an illustrative embodiment of a mode converter 330 having a tapered waveguide 104 formed on a SOI wafer 102. The a tapered waveguide 104 is coupled to a SMF 120 at a first end 334, while other devices, such as waveguide devices or lasers, e.g. semiconductor lasers, are couple to a second end 338. In one embodiment, the mode converter 330 is tapered in the lateral dimension before tapering in the vertical dimension. In an alternative embodiment, the mode converter 330 is tapered in both the lateral and vertical dimensions substantially simultaneously. In yet another embodiment, the mode converter is tapered in the vertical dimension prior to the lateral dimension.

In an exemplary embodiment, the mode converter 330 is about 2.9 mm in length. A straight input section of the tapered waveguide 104 is about 0.15 mm to about 2.9 mm long. The tapered section is about 0 mm to about 2.75 mm in length with varying taper angles used to achieve a desired range of output facet widths. For example, to mode match a SMF, the input facet and straight section of the mode converters have a width and height of about 11.5 μm ×11.5 μm. The angle of the tapered section ranges from about 0.18 degrees to about 1.07 degrees, which yields output ends 338 with a width and height of about 2.3 μm ×2.3 μm to about 11.5 μm ×11.5 μm. The input and output ends 334 and 338 need not be square. For example, the waveguide 104 may only be tapered in one dimension; alternatively, one of the vertical or lateral tapers may have a larger taper angle than the other, resulting in a rectangular shape for the input and output ends 334 and 338.

The SOI wafer 102 was about 525 μm thick with a <100> orientation handle and about 1-10 ohm-cm resistivity. The buried oxide layer was about 1 μm thick, while the device layer was about 11.5 μm thick. The taper structures may be patterned onto the wafers using a contact lithographic process performed using a Karl Suss MA6 aligner operated in proximity mode and a about 3 μm photo resist process (Shipley S1813 resist). Once the resist is patterned, the mode converter patterns are etched into the Si device layer using a Unaxis reactive ion etch, e.g., a Bosch deep reactive ion etch (DRIE) process. The DRIE process is highly selective to both photoresist and oxide, thereby allowing the resist to be used as a mask and the buried oxide layer to be used as a stop layer. Once the resist pattern is transferred into the Si, the resist layer is removed by ashing in an oxygen plasma. Following the etch step, the SOI wafer 102 may be processed through a thermal oxidation step to reduce the sidewall roughness.

Once the wafer level processing is complete, the wafers are diced into die, each of which include two full sets of the 14 mode converter designs. The die has Pyrex cover slips bonded using Epotek 353ND epoxy to minimize chipping of the end facet during subsequent processing. The input and output ends of the cover slipped die are lapped to target dimensions using Buehler polishers with fixed abrasive pads, and then are polished to a surface finish of 4 nm RMS using Engis planetary polishers with diamond slurries. The surface morphology of the polished facets can be verified using a Zygo New View 5032 interferometric surface profiler. Using fiducial marks on the die, the end facet polishing can be controlled to within +/−25 μm along the long axis of the mode converter. Polished samples may be coated with a multi-layer AR coating on both the input and output ends. The coatings are designed for low reflectivity (<about 0.8%) at a wavelength of 1550 nm for an output medium of either air (n=1.0) or glass (n=1.45).

Once the die processing is complete, the die may be optically screened to determine the insertion loss (IL) and to image the output mode field for each of the mode converter designs. Following characterization of the mode converters on a die level, individual mode converters 330 may be selected for bonding to the SMF input fiber 120. In one embodiment, an Epotek OG-198 UV/heat cured Epoxy may be used for bonding.

In some embodiments, the mode converter 330 is tapered in the lateral dimension first. To taper in the vertical dimension, the SOI wafer 102 is diced into strip die, and the top surface of the die is polished to produce a vertical wedge on the mode converter 330. In various embodiments, the slope of the vertical taper of the tapered waveguide 104 matches the lithographically defined lateral taper. Polishing may be performed using custom angle fixturing and planetary polishers using diamond slurries. The vertically sloped surface of the samples are polished to a finish of <about 10 nm RMS. The use of strip die, with many mode converters per die, produces an economically practical manufacturing approach in which many mode converters are processed in a single polishing run. Since the same mask set is used for the lateral-only and two-stage tapers, the two-stage tapers may be arranged in arrays of 14 tapers and may have output end 338 widths of about 2.3 μm to about 11.5 μm. In various embodiments, the mask and etch process and/or the polish process may be selected such that the lateral and vertical dimension are as small as about 1 μm. The SOI wafers 102 may be oxidation smoothed.

FIG. 5 illustrates a tapered waveguide 350 fabricated using the methods and techniques of the invention described. The waveguide 350 converts the circular mode of an optical fiber 120 to an elliptical mode, or vice versa. The output 354 shows an elliptical mode formed when the smaller end 358 is utilized as an output end and an optical fiber 120, serving as an input, is attached to the larger end 362. Approximately 85 percent of the power from the optical fiber is transmitted into the elliptical mode

The input end is approximately square in shape with dimensions of about 10.5 μm ×10.5 μm. A tapered portion 366 is represented schematically as a semiconductor section having a taper in one dimension and a length of about 1 mm, although other lengths and taper angles are achievable. In the exemplary structure shown in FIG. 5, the tapered portion 366 terminates at an output end 358 having dimensions of about 10.5 μm ×3 μm. The output 354 is an optical beam or signal having a substantially elliptical shape and the majority of its power in a mode 0 described by two orthogonal Gaussian beam profiles. In some embodiments, a portion of the output power may appear in a mode other than mode 0.

FIG. 6 depicts a first tapered waveguide 370 coupled to a first SMF 120 at a first end 374, and a second tapered waveguide 378 coupled to a second SMF 120′ at a second end 382. The tapered waveguides 370 and 378 may be fabricated using the techniques and methods described above and may be identical to the waveguide 350 shown in FIG. 5. The output end 386 of the first tapered waveguide 370 is coupled to a semiconductor optical amplifier (SOA) 390, while the input end 394 of the second tapered waveguide 378 is coupled to the SOA 390. The shape of the mode transmitted through the first SMF 120 is converted from circular to elliptical by the first tapered waveguide 370 for processing within the SOA 390, which has an inherent elliptical mode shape. Then the mode is converted back to circular by the second tapered waveguide 378 for transmission to the second SMF 120′.

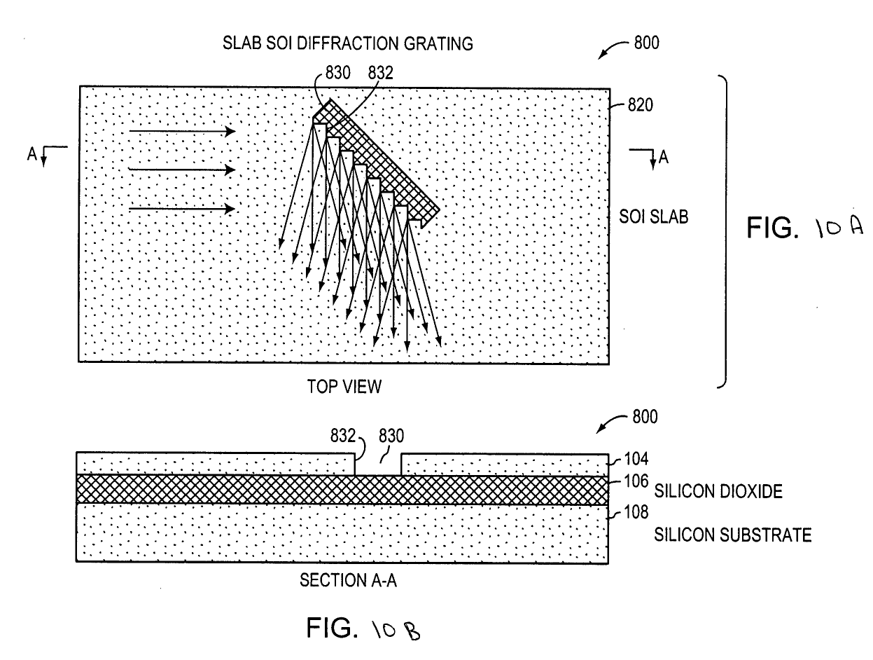

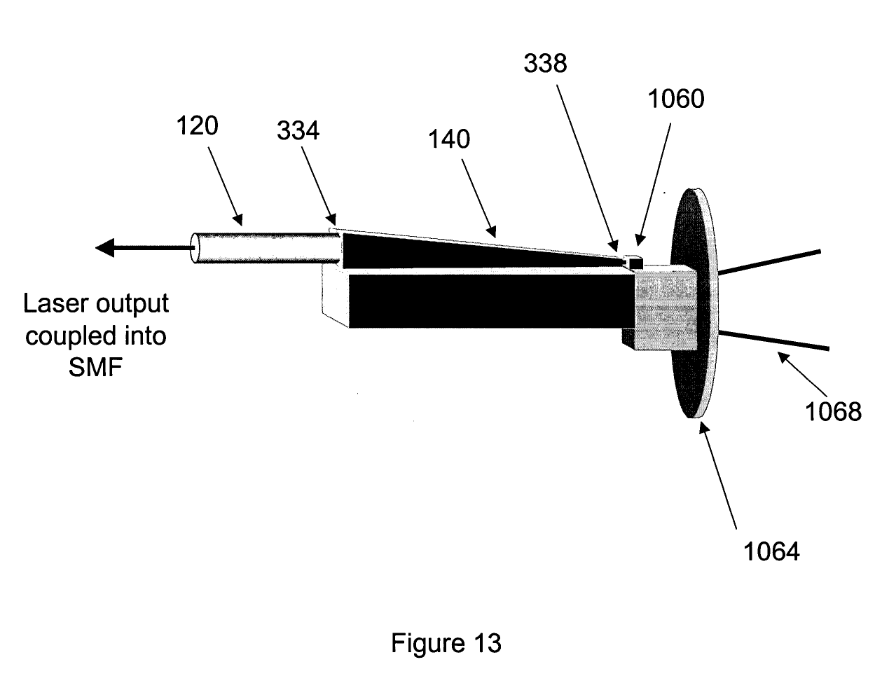

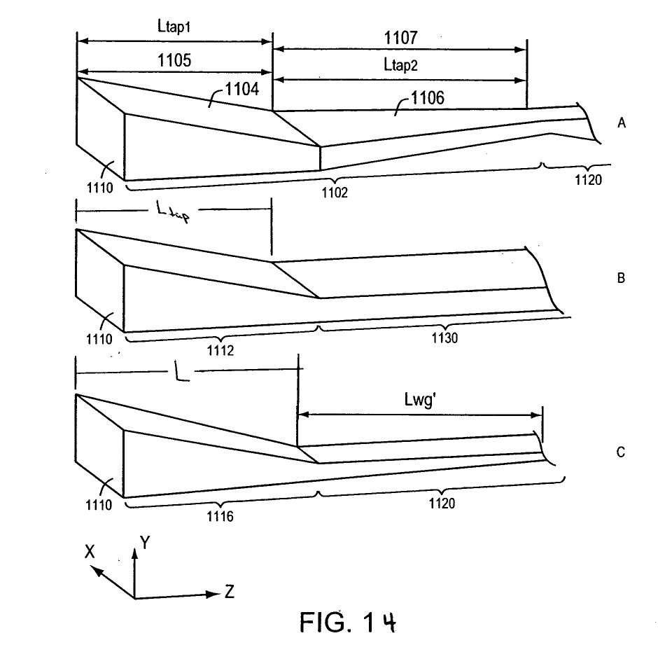

Other optical devices, such as, for example, waveguide devices and semiconductor lasers, may be coupled to the smaller ends of the tapered waveguides 104, 350, 370, and 378 shown in FIGS. 4, 5, and 6. For example, FIGS. 7 and 8 depict optical devices coupled directly to a SMF. The mode converter of the present invention may inserted between the SMF and the device to more efficiently couple the mode propagating in the SMF to the device. Likewise, FIGS. 9-12 show optical devices that can be coupled to a SMF using a mode converter of the invention. FIG. 13 illustrates the mode converter 330 shown in FIG. 4 coupling a semiconductor laser to a SMF.

FIG. 7A is a diagram 500 that shows a top view of a first illustrative embodiment of an optical component for coupling a conventional optical fiber to a waveguide. The optical fiber 120 is clamped or welded in place in an anisotropically etched V groove 522 at the edge of a silicon substrate 520. FIG. 7B is a diagram that shows a section through the thickness of the illustrative embodiment shown in FIG. 7A. The optical fiber 120 is butted against the SOI layer 104 where the substrate has been etched away from under the insulating layer 106, so that a waveguide strip 530 connected to the rest of the slab is cantilevered over the silicon substrate 520. The strip 530 is long enough so that the light passing through the silicon dioxide will transfer into the silicon on top. There are many subtleties to be optimized in this component. For example, the light wave coming out of the fiber is usually single mode. It is desirable for many applications to maintain a single mode. As the light wave transfers from the fiber to the SOI higher order modes are likely to be generated. It may be necessary to provide silicon dioxide on both the top and bottom of the SOI layer, and it may be necessary to provide a long taper in the thickness of the SOI to reduce it to zero thickness at the junction with the fiber.

FIG. 8A is a diagram 600 that shows a top view of a second illustrative embodiment of an optical component for coupling a conventional optical fiber to a SOI waveguide. This embodiment comprises a lens 625. The light enters the SOI slab 610 from an optical fiber 120 via the fiber optic connection 615, shown here in an abbreviated form, then is spread outward by a diffractive element, not shown. The light then enters the lens 625. The lens 625 comprises a region of thinner silicon.

FIG. 8B is a diagram that shows a section through the thickness of the optical component shown in FIG. 8A. The thinner silicon has a smaller effective refractive index causing the light passing across the steps to refract. To make the lens efficient, steps 630 are used to minimize reflection of the light from the refraction interface.

The steps 630 are shown in more detail in FIG. 9A. FIGS. 9A and 9B are diagrams that show cross-sections of examples of illustrative transition structures used to minimize reflection of the light from the refraction interface between the waveguide and the optical fiber. FIG. 9B shows a sloped wall 720 that is used as an alternative to the structure of FIG. 9A.

FIGS. 9C, 9D and 9E are diagrams that show an illustrative example of the fabrication process used to manufacture a transition structure such as that shown in FIG. 9B. FIG. 9C shows a wafer which includes a silicon nitride mask 740, formed on the silicon layer 104 by reaction with a nitrogen bearing gas such as ammonia (NH₃), or by deposition of Si₃N₄ for example by chemical vapor deposition (CVD). The nitride can be deposited over a thin oxide grown on the silicon 104 waveguide layer. The silicon exposed by the gap in the nitride layer is oxidized. The oxide 750 grows radially beneath the nitride as shown in FIG. 9D. By varying the thickness of the nitride film 740 and its underlying stress release oxide not shown, the radial growth and thus the slope of the oxide interface can be controlled over a range of different values. Finally the nitride mask and oxide are removed, leaving the silicon structure 720 shown in FIG. 9E.

With an appropriately designed lens, a parallel beam emerges from the lens. Because the SOI slab wave-guide is asymmetrical, the guide cuts off if the silicon is very thin. In some embodiments, the silicon dioxide is removed from under the lens region to avoid losing the light in the guide.

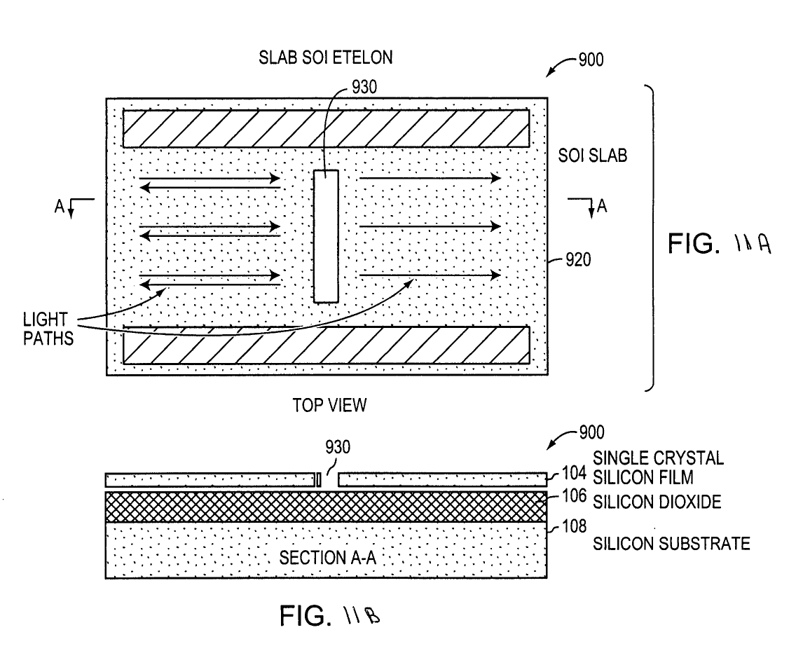

FIGS. 10A and 10B are diagrams 800, in top view and in cross-section, respectively, that show an illustrative embodiment of a diffraction grating 830 etched into the SOI slab waveguide 820. The grating is fabricated by silicon lithography and etching processes. A mask is fabricated describing the grating. The SOI wafer is coated with photoresist, exposed with the grating mask in place, developed, and etched. The process removes the silicon film in the form of the grating. Thus, the grating teeth form the edges of the slab waveguide. Light propagating through the waveguide that strikes the grating is dispersed into its multiple wavelengths upon reflection from the grating. The exposed surface 832 of the grating may be coated with a reflective material such as aluminum to enhance the grating efficiency.

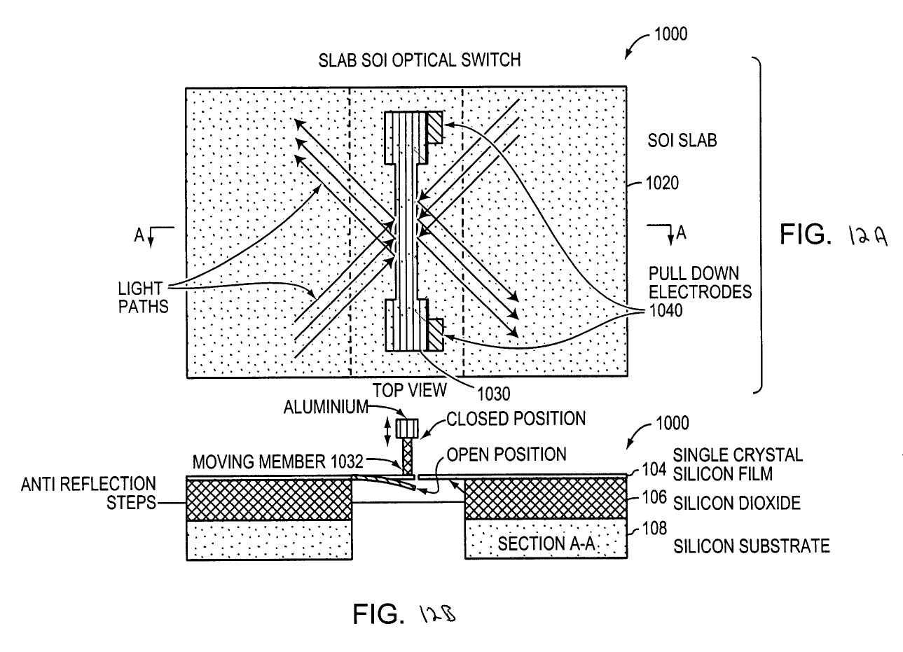

FIGS. 11A and 11B are diagrams, generally 900, that show an illustrative embodiment comprising an etalon 930, in top view and in cross-section, respectively. The etalon 930 is simply a slit etched in the silicon wafer 920 and associated layers providing a resonance, which will pass only one wavelength band making a filter. The slit width can be accurately controlled with state of the art lithography. In this etalon 930 device, as in the other structures described above, the surfaces which are etched in the silicon must be smooth to avoid scattering and to make a narrow band width etalon 930. Smoothing techniques can be used to reduce the roughness, which is expected to be around 2 nm before smoothing. Modifications and variations of this design can be constructed, to tune the etalon to minimize loss.

FIGS. 12A and 12B are diagrams, generally 1000, that show an illustrative embodiment of a micro electro mechanical optical switch 1030, in top view and in cross-section respectively. An aluminum member 1032 is pulled down into contact with a thinned section of slab guide 1020. The light, which is moving 45 degrees relative to the direction of the member 1032, can pass with low loss when the member 1032 is in the up position. When the member 1032 is down, the light reflects with high efficiency at 90 degrees. Such a switch could be used to drop out a light path or it could be used in a cross bar switch. The switch further comprises electrodes 1040 used to electrically operate the switch 1030.

Additional elements, which are important in optical communication components, are attenuators for absorbing the scattered light. A high resistance metal layer on the silicon can help absorb the light in the silicon, and implantation in the silicon dioxide can provide loss in insulating layer.

FIG. 13 depicts a tapered waveguide 104 coupled to a SMF 120 at a first end 334. At a second end 338, the tapered waveguide 104 is coupled to a diode laser 1060 mounted on a laser submount 1064, which includes electrical connections 1068. The fundamental mode of the first end 334 of the tapered waveguide 104 is matched to the fundamental mode of the SMF 120, and the fundamental mode of the second end 338 of the tapered waveguide 104 is matched to the output mode of the laser diode 1060. The mode diameter of optical radiation propagating from the diode laser 1060 through the tapered waveguide 104 to the SMF 120 expands while propagating through the tapered waveguide 104. This provides mode matching between the laser diode 1060 and the SMF 120, which otherwise have disparate mode field diameters and geometries, results in more efficient coupling. The tapered waveguide 104 may be fabricated using the techniques and methods described above and may be identical to the waveguide shown in FIGS. 4 or 5.

In one embodiment of the device shown in FIG. 13, the tapered waveguide 104 is fabricated from Si on a SOI wafer, is 2.9 mm in length, and has a first end 334 with a cross sectional dimension of about 11.5 μm ×11.5 μm. The first end 334 is mode matched to the SMF 120, which has a circular mode with a diameter of about 10.4 μm. In this embodiment, the second end of the tapered waveguide 338 has a cross sectional dimension of about 3.5 μm ×3.0 μm and a fundamental mode diameter of about 2.7 μm ×2.4 μm. The surface roughness of the tapered waveguide is about 22 nm rms. The diode laser 1060 may be, for example, a Fabry-Perot InGaAsP multi-quantum well laser operating at a wavelength of about 1550 nm and a power of about 5 mW (continuous wave operation). The output mode field of the laser is ovular with a cross sectional dimension of about 2.6 μm ×2.5 μm. In this embodiment, the measured coupling efficiency of output power from the diode laser 1060 into the SMF 120 is about 74.98 percent, which represents an insertion loss of about 1.25 dB.

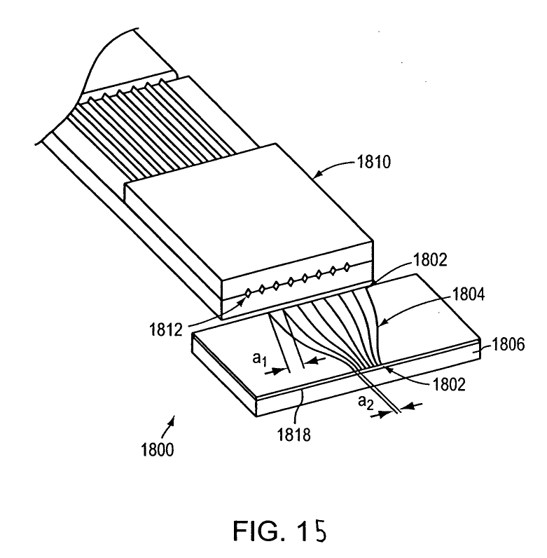

FIG. 14 shows three illustrative taper designs for optical couplers of the invention. At the bottom of FIG. 14 are a set of orthogonal axes, labeled x, y, and z, which indicate how dimensions are measured in the illustrative designs. FIG. 14A depicts a taper design for use in connecting a single mode optical fiber (not shown) to a single mode waveguide. Single mode optical fibers are well known in the optical communication arts. In the following description, light is described as being delivered by a single mode fiber to the optical coupler of the invention, and therethrough to a waveguide. It will be recognized that the coupler is bi-directional and that the direction of communication of the light can equally well be from the waveguide to the coupler and therethrough to the optical fiber. Bi-directional communications can be performed simultaneously or sequentially.

In FIG. 14A, radiation from such a fiber impinges on a facet 1110 of a dual stage optical coupler 1102. The facet 1110 is designed to accept optical radiation from a source with minimized losses. In some embodiments, the facet 1110 comprises an optical coating applied to the surface thereof. Coatings adapted to reduce reflective losses, known in the optical arts as anti-reflection coatings, are commonly employed in lenses for cameras and binoculars, in photovoltaic solar cells, in optical filters, and the like. Dual stage optical taper 1102 comprises a first tapered region 1104 which is tapered in a first dimension and of substantially constant width in a second dimension. The first tapered region has a length 1105 denoted by the label Lₜₐₚ₁. Dual stage optical taper 1102 further comprises a second tapered region 1106 which is substantially constant in the first dimension, and is tapered in the second dimension. The second tapered region has a length 1107 denoted by the label Ltap₂.

The optical taper 1102 has an end that abuts an end of single mode waveguide 1120. The waveguide 1120 is a structure having a substantially constant cross section, the cross section being measured in a plane perpendicular to the direction of propagation of light in the waveguide 1120. In a preferred embodiment, the waveguide 1120 comprises a silicon structure, such as a strip of silicon. In a preferred embodiment, the waveguide 1120 has a cross sectional dimension that is less than 380 nm. In a further preferred embodiment, the waveguide 1120 propagates only one optical mode.

FIG. 14B shows an illustrative taper design in which a single mode fiber (not shown) is in communication with a multimode waveguide by way of an optical coupler of the invention. In FIG. 14B, light from the optical fiber enters facet 110 of optical coupler 1112, which is tapered in only one cross sectional dimension. The length of the tapered region is denoted by Lₜₐₚ. The optical coupler 1112 has an end that abuts an end of multimode waveguide 1130, which is a strip of semiconductor material, such as silicon.

FIG. 14C shows an illustrative taper design in which a single mode fiber (not shown) communicates with a single mode waveguide 1120 by way of optical coupler 1116. In this embodiment, optical coupler 1116 has two cross sectional dimensions that both change in a single tapered region. The length of the tapered region is denoted L. While all of the illustrative tapers are shown as linear tapers, it will be understood that tapers having non-linear cross sectional variations are also contemplated. As already indicated, an important feature of the invention is that the cross sectional dimension is accurate to within 50 nm tolerance of the desired value. Another important feature of the invention is that the waveguide comprise a surface having a surface roughness of less than 3 nm rms.

FIG. 15 is a schematic diagram of an illustrative application using the optical coupler of the invention. In this exemplary application, a plurality of communication paths operate in parallel. An optical communication 1800 device that has an optical coupler 1802 disposed at each end of a semiconductor waveguide 1804 is provided for each path. In one embodiment, such as is shown in FIG. 15, a plurality of optical communication devices are fabricated on a single semiconductor substrate 1806, such as a SOI wafer. The optical couplers 1802 and the waveguide 1804 of a single communication device can be fabricated so that at least a portion of each is adjacent the same oxide layer 1808, e.g., the insulator (silicon dioxide) layer of the SOI wafer. The optical communication devices can be fabricated so that a plurality of first optical couplers are disposed relative to each other with first selected positions and orientations.

In one embodiment, two or more optical couplers can be spaced apart with a first spacing, denoted a, in FIG. 15, and can be aligned parallel to each other in a first plane, so as to accommodate an optical fiber array cable 1810 having a planar array of optical fibers 1812 with a first spacing. At the other end of the optical communication device, in one embodiment, there can be a group of optical couplers disposed in a pattern having a second spacing, denoted a₂, different from the first spacing, and oriented in a different plane, or in a non-planar alignment. Thus, there can be a plurality of second couplers disposed relative to each other with second selected positions and orientations. For the optical communication device to be operative, at least one coupler of the first plurality and at least a corresponding coupler of the second plurality are in communication with a light source and a detector, respectively.

As will be understood by those of skill in the optical communication arts, a communication device of the invention can be operated uni-directionally or bi-directionally, in half-duplex or in full duplex mode. Furthermore, a single optical communication device can be used to simultaneously or serially communicate a plurality of communications using a discrete wavelength for each communication, such as is practiced in DWDM communication.

### Equivalents

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A mode converter comprising a silicon waveguide core deposited over a first silicon dioxide cladding layer, the silicon waveguide core polished such that a first end of the silicon waveguide core has a larger cross-sectional area than a second end of the silicon waveguide core.

2. The mode converter of claim 1, wherein the silicon waveguide core comprises a vertical taper.

3. The mode converter of claim 1, wherein the silicon waveguide core comprises a lateral taper.

4. The mode converter of claim 2, wherein the silicon waveguide core comprises an angled top surface and a flat bottom surface.

5. The mode converter of claim 3, wherein the slope of the vertical taper matches the slope of the lateral taper.

6. The mode converter of claim 1 further comprising a second silicon dioxide cladding layer deposited over the silicon waveguide core to provide a symmetric clad.

7. The mode converter of claim 1 further comprising a silicon substrate, wherein the first silicon dioxide cladding layer and the silicon waveguide core are formed over the silicon substrate.

8. The mode converter of claim 1, wherein the second end of the silicon waveguide core has at least one dimension of about 1 μm.

9. A method of forming a mode converter comprising:
depositing a silicon waveguide core over a first silicon dioxide cladding layer; and
polishing the silicon waveguide core such that a first end of the silicon waveguide core has a larger cross-sectional area than a second end of the silicon waveguide core.

10. The method of claim 9, wherein the polishing step includes vertically tapering the silicon waveguide core.

11. The method of claim 9 further comprising tapering the silicon waveguide core laterally using a lithographic mask and etch process.

12. The method of claim 10, wherein the silicon waveguide core comprises an angled top surface and a flat bottom surface.

13. The method of claim 11 further comprising matching the slope of the vertical taper to the slope of the lateral taper.

14. The method of claim 9 further comprising depositing a second silicon dioxide cladding layer over the silicon waveguide core to provide a symmetric clad.

15. The method of claim 9 further comprising forming the first silicon dioxide cladding layer and the silicon waveguide core over a silicon substrate.

16. The method of claim 9 further comprising mode matching the first end to a single mode fiber.

17. The method of claim 9 further comprising mode matching the second end to one of a group consisting of a waveguide device and a semiconductor laser.

18. A mode converter comprising a silicon waveguide core deposited over a first silicon dioxide cladding layer, the silicon waveguide core being tapered using a gray-scale lithographic mask and etch process such that a first end of the silicon waveguide core has a larger cross-sectional area than a second end of the silicon waveguide core.

19. The mode converter of claim 18, wherein the silicon waveguide core comprises a vertical taper.

20. The mode converter of claim 19, wherein the silicon waveguide core comprises a lateral taper.

21. The mode converter of claim 20, wherein the slope of the vertical taper matches the slope of the lateral taper.

22. The mode converter of claim 18 further comprising a second silicon dioxide cladding layer deposited over the silicon waveguide core to provide a symmetric clad.

23. The mode converter of claim 18 further comprising the first silicon dioxide cladding layer and the silicon waveguide core formed over a silicon substrate.

24. The mode converter of claim 18, wherein the second end of the silicon waveguide core has at least one dimension of about 0.25 μm.

25. A method of forming a mode converter, the method comprising:
depositing a silicon waveguide core over a first silicon dioxide cladding layer; and
using a gray-scale lithographic mask and etch process on the silicon waveguide core such that a first end of the silicon waveguide core has a larger cross-sectional area than a second end of the silicon waveguide core.

26. The method of claim 25 further comprising vertically tapering the silicon waveguide core using the gray-scale lithographic mask and etch process.

27. The method of claim 26 further comprising laterally taper the silicon waveguide core using the gray-scale lithographic mask and etch process.

28. The method of claim 27 further comprising matching the slope of the vertical taper to the slope of the lateral taper.

29. The method of claim 25 further comprising depositing a second silicon dioxide cladding layer over the silicon waveguide core to provide a symmetric clad.

30. The method of claim 25 further comprising forming the first silicon dioxide cladding layer and the silicon waveguide core over a silicon substrate.

31. The method of claim 25 further comprising mode matching the first end to a single mode fiber.

32. The method of claim 25 further comprising mode matching the second end to one of a group consisting of a waveguide device and a semiconductor laser.
